(19) United States
(12) Patent Application Publication
(10) Pub. No.: US 2013/0157232 A1
(43) Pub. Date: Jun. 20, 2013

(54) SYSTEM AND METHODS FOR MONITORING FOOD CONSUMPTION

(71) Applicant: Joel Ehrenkranz, Salt Lake City, UT (US)

(72) Inventor: Joel Ehrenkranz, Salt Lake City, UT (US)

(73) Assignee: Joel Ehrenkranz, Salt Lake City, UT (US)

(21) Appl. No.: 13/708,576

(22) Filed: Dec. 7, 2012

Related U.S. Application Data
(60) Provisional application No. 61/569,074, filed on Dec. 9, 2011.

(51) Int. Cl. G09B 19/00

(52) U.S. Cl. CPC G09B 19/0092
USPC 434/127; 206/459.1

(57) ABSTRACT

The invention provides a system for monitoring food consumption of a subject, comprising: a registration system configured to receive food data comprising nutrients and/or calories contained in one or more food item served to the subject; an intake detection system configured to detect consumption of said one or more food item, thereby generating real-time food consumption data; and a tracking and analysis system configured to receive food data from said registration system and consumption data from said intake detection system, and configured to utilize said food data and said consumption data to calculate a total amount of one or more nutrient and/or calories consumed by the subject. The invention further provides methods for monitoring food consumption of a subject.

### CROSS-REFERENCE TO RELATED APPLICATIONS

This application claims priority under 35 U.S.C. Section 119(e) and the benefit of U.S. Provisional Application Ser. No. 61/569,074 filed Dec. 9, 2011, the entire disclosure of which is incorporated herein by reference in its entirety.

### FIELD OF THE INVENTION

The invention described herein relates to systems and methods for monitoring food consumption and for providing real-time, detailed, nutrient-specific consumption data.

### BACKGROUND OF THE INVENTION

Monitoring of food consumption while eating is useful for general public health maintenance and overall training and conditioning, as well as the management of particular diseases. Certain diseases or medical conditions require a special diet to manage or eliminate symptoms. Such specialized diets typically require limiting the consumption of particular nutrients, for example, carbohydrates for individuals with diabetes, protein for individuals with liver disease, or sodium for individuals with hypertension. In addition, many individuals desire to regulate their consumption of total calories or of nutrients such as saturated fats so as to aid in the prevention of conditions such as obesity or heart disease. Furthermore, individuals who are training for athletic events need to monitor their nutrition. Lastly, individuals on medications, such as warfarin, whose therapeutic effects are altered by the consumption of specific foods (e.g. vitamin K containing foods), must monitor their consumption of specific foods and ingredients.

Current systems and devices for monitoring food consumption typically provide food consumption data that is summarized at an aggregate level following the completion of eating, for example, providing a total amount (by weight or by total calories), rather than providing levels of individual nutrients (for example, the systems and methods described in U.S. Pat. No. 4,049,950 and U.S. Application No. 2010/009876). These systems tend to be subjective and not quantitative. While systems have been proposed that would allow for collection of more detailed nutritional information, these systems typically base the determination of nutrient consumption on inputs of food intended to be eaten, rather than what is actually consumed (for example, the systems and methods described in U.S. Pat. Nos. 6,283,914, 6,978,221, and 6,425,862), or only provide detailed nutritional information after consumption has already occurred (for example, the systems and methods described in U.S. Pat. Nos. 7,432,454 and 7,541,548).

The need for real-time data on food consumption is particularly relevant in the treatment of diabetes. Currently recommended methods for insulin dosing with meals are based upon estimating the amount of carbohydrates an individual expects to consume at a meal, and then dosing with an amount of insulin based upon this anticipated carbohydrate consumption. To attempt to mimic the cephalic phase of insulin secretion and to match insulin activity with the rise in blood glucose that occurs with carbohydrate consumption, insulin should be administered prior to or within five minutes of starting to eat a meal. For regular insulin, it is typically recommended that insulin be injected 30 minutes before meals. For rapid acting insulins such as Humalog, Novolog and Apidra, FDA approved labeling recommends injection from 10-15 minutes prior to or five minutes after the start of eating. These guidelines are problematic for a number of reasons, primarily inconvenience of insulin dosing at the recommended time prior to meals, and inaccurate or unreliable estimation of the amount of carbohydrates that will be consumed.

Hospitalized patients for whom insulin is prescribed generally receive insulin after they have finished eating. This practice represents a deviation from FDA-approved guidelines for insulin administration, results in sub-optimal glycemic control, and puts the patient at risk for both hypoglycemia and hyperglycemia. Additionally, the practice entails additional work for nursing staff, as the amount of carbohydrates consumed must be estimated for each patient and manually charted. Thus there is an unmet need for a method of providing real-time data on carbohydrate consumption so that insulin dosing can be provided in a timely manner to optimize blood glucose control. Additionally, there is a need for more precise, real-time measurement of nutrition for all hospitalized patients including individuals with diabetes as well as other common metabolic problems such as obesity, hypertension, heart failure, renal failure, and hyperlipidemia. Finally, real-time measurement of nutritional intake is needed to allow individuals to manage their body weight, fitness, training or nutritional goals.

Food delivery systems and consumption tracking systems often fail to provide real-time, detailed, nutrient-specific data. Currently available methods involve the use of food scales and nutritional tables to calculate the calorie content and nutritional components of various food items at the time of preparation. This is a cumbersome and inconvenient manual process which is prone to error. Thus there is a need for an automated method to provide information on actual calories and nutrients ingested and to store this information for subsequent review and analysis. Increased data accuracy, detail and timeliness will assist medical practitioners, patients, and medical control devices in diagnosing, monitoring and regulating therapies for patients, as well as assisting individuals in setting, monitoring and meeting their personal nutritional and fitness goals. Therefore, a need exists in the art for a system and method that provides detailed, real-time, nutrient-specific food consumption data.

### SUMMARY OF THE INVENTION

The present invention relates to systems and methods for monitoring food consumption and for providing real-time, detailed, nutrient specific consumption data.

In an embodiment, the invention provides a system for monitoring food consumption comprising: a registration system configured to receive food data comprising nutrients and/or calories contained in one or more food items served to the subject; an intake detection system configured to detect consumption of said one or more food items, thereby generating real-time food consumption data; and a tracking and analysis system configured to receive food data from said registration system and consumption data from said intake detection system, and configured to utilize said food data and said consumption data to calculate a total amount of one or more nutrients and/or calories consumed by the subject.

In various embodiments, the intake detection system detects consumption of one or more food items by measuring a change of weight; a change of volume; a change in the amount of a detectable label present in the food item; or mouthfuls of food taken by the subject.

In some embodiments, the intake detection system comprises one or more sensing devices configured to detect a change in weight in one or more food items served to the subject as the food items(s) are consumed by the subject. In some embodiments, the intake detection system comprises a tray, wherein the tray comprises one or more sensing devices configured to detect a change in weight of one or more food items on the tray as said one or more food item is consumed by the subject. In some embodiments, the tray comprises a plurality of discrete regions, and wherein the one or more sensing devices are configured to detect a change in weight occurring in one or more of said plurality of discrete regions. In other embodiments, the intake detection system comprises a utensil, wherein the utensil comprises a sensing device configured to detect the weight of food removed by the utensil from a food item served to the subject, and further comprises a device that monitors the location and identity of each food item and monitors where the utensil is used, wherein the utensil communicates wirelessly with said device to send the food consumption data.

In some embodiments of any of the systems described above, the one or more sensing device comprises a weighing device operably connected to a sensor. In various embodiments, the weighing device is selected from a load cell, a spring balance, a fluid or gas-filled bladder, and a hydraulic scale.

In some embodiments of the systems of the invention, the registration system and the tracking and analysis system are comprised within a device selected from a personal computer, a tablet and a smart phone. In some embodiments, the registration system and the tracking and analysis system are wirelessly connected to the intake detection system.

In some embodiments of the systems of the invention, the system comprises a user interface configured so that a user can input food data. In some embodiments, the system comprises a user interface configured so that a user can input nutritional consumption goals. In some embodiments, the system further comprises a processing module operable to utilize the input data concerning consumption goals combined with the real-time consumption data and/or the results of calculations by the tracking and analysis engine to calculate progress towards one or more consumption goal. In some embodiments, the system comprises a user interface configured so that a user can input data concerning the weights of utensils and food vessels used to serve one or more food item. In some embodiments of the systems of the invention, the system comprises a processing module operable to utilize the input data concerning the weights of utensils and food vessels used to serve one or more food items to correct for changes in weight due to movement of said utensils and/or food vessels.

In some embodiments of any of the systems disclosed above, the system comprises a display device operably linked to the tracking and analysis system and configured to display in real time an amount of one or more nutrient and/or calories consumed by the subject. In some embodiments, the display device is further configured to display progress towards one or more nutritional consumption goals. In some embodiments of any of the systems disclosed above, the system comprises a processing module operable to generate a message containing eating advice for the subject based upon the real-time consumption data and/or the results of calculations by the tracking and analysis engine; and means for delivering the message to the subject. In some embodiments, the processing module is further operable to generate a message containing eating advice for the subject based upon the input data concerning consumption goals and/or the calculated progress towards one or more consumption goal.

In some embodiments of the systems of the invention, the registration system is configured to receive information from a data identifier associated with a food item. In some embodiments, the data identifier is a label attached to a container comprising a food item or a bar code or RFID chip affixed to the food packaging. In some embodiments, the data identifier is a flag attached by a user to a food item or a vessel containing the food item.

In some embodiments of the systems of the invention, the intake detection system further comprises an initiator configured to detect the commencement of food consumption. In various embodiments, the initiator is a button or sensor. In some embodiments, the initiator is a band wrapped around one or more utensils, wherein breaking of the band transmits a signal to the intake detection system.

In some embodiments, the system comprises one or more external data sources operably connected to the registration system. In some embodiments, the system comprises one or more data repositories operably connected to the tracking and analysis system. In some embodiments, the system comprises one or more timers operably connected to one or more of the registration system, the food intake system, and the tracking and analysis system.

In some embodiments of the systems of the invention, the system comprises a control device configured to receive data from the tracking and analysis system. In some embodiments, the control device generates a signal or message when a predetermined total amount of a nutrient has been consumed by the subject. In some embodiments, the control device is a drug delivery system which delivers a drug to the subject based upon the amount of one or more nutrients consumed by the subject as calculated by the tracking and analysis system. In some embodiments, the drug delivery system delivers insulin to the subject based upon the amount of carbohydrates consumed by the subject as calculated by the tracking and analysis system.

In some embodiments, the system of the invention is a food tray, or “smart tray”. In some embodiments, the invention provides a food tray comprising: a data interface configured to receive food data associated with one or more food items on the food tray; a sensing device configured to detect a change in weight of one or more food item on the tray, thereby generating real-time food consumption data; an analysis module configured to analyze the food data and the real-time food consumption data to generate consumption analysis data providing the total amount of one or more nutrient and/or calories consumed by the subject; and a memory configured to store at least one of the food data, the consumption data, and the consumption analysis data. In some embodiments, the food tray comprises a plurality of discrete regions, and a plurality of sensing devices, wherein each of the plurality of sensing devices is configured to detect a change in weight in one of the plurality of discrete regions.

In some embodiments of the food tray of the invention, the sensing device, or one or more of the plurality of sensing devices, comprises a weighing device operably connected to a sensor. In various embodiments, the weighing device is selected from a load cell, a spring balance, a fluid or gas-filled bladder, and a hydraulic scale.

In some embodiments, the data interface of the food tray is configured to receive information from a data identifier associated with a food item. In some embodiments, the data interface is configured so that a user can input food data. In some embodiments, the data interface is configured so that a user can input nutritional consumption goals. In some embodiments, the food tray comprises a processing module operable to utilize the input data concerning consumption goals combined with the real-time consumption data and/or the results of calculations by the tracking and analysis engine to calculate progress towards one or more consumption goal. In some embodiments, the data interface is configured so that a user can input data concerning the weights of utensils and food vessels used to serve one or more food items. In some embodiments, the food tray comprises a processing module operable to utilize the input data concerning the weights of utensils and food vessels used to serve one or more food item to correct for changes in weight due to movement of said utensils and/or food vessels.

In some embodiments, the food tray comprises a display device operably linked to the analysis module and the memory and configured to display an amount of one or more nutrient and/or calories consumed by the subject. In some embodiments, display device is further configured to display progress towards one or more nutritional consumption goals. In some embodiments, the food tray comprises a processing module operable to generate a message containing eating advice for the subject based upon the real-time consumption data and/or the consumption analysis data; and means for delivering the message to the subject. In some embodiments, the processing module is further operable to generate a message containing eating advice for the subject based upon the input data concerning consumption goals and/or the calculated progress towards one or more consumption goal.

In some embodiments, the food tray comprises a database containing food nutrition data. In some embodiments, the tray comprises one or more timers. In some embodiments, the food tray is configured to communicate with one or more external data sources. In some embodiments, the food tray comprises an initiator configured to detect the commencement of food consumption. In various embodiments, the initiator is a button or sensor. In some embodiments, the initiator is a band wrapped around one or more utensils, wherein breaking of the band transmits a signal to the intake detection system.

In some embodiments, the food tray is configured to send consumption analysis data to a control device. In some embodiments, the control device is a drug delivery system which delivers a drug to the subject based upon the amount of one or more nutrients consumed by the subject as determined by the analysis module. In some embodiments, the drug delivery system delivers insulin to the subject based upon the amount of carbohydrates consumed by the subject as determined by the analysis module.

In various embodiments of any of the systems or food trays disclosed above, the tray comprises two or more foldable segments, each segment comprising a scale, and wherein the foldable segments are configured so that the tray is convertible between an open and a folded configuration. In some embodiments, any of the disclosed trays is in the shape of a rectangle with rounded corners and is substantially flat. In some embodiments, any of the disclosed trays has dimensions of about 40 cm or less in length, 50 cm or less in width, and 3 cm or less in thickness, and a weight of 1 kg or less. In some embodiments, any of the disclosed trays is made from a waterproof plastic material.

The invention further provides methods for monitoring real-time food and nutrient consumption. In some embodiments, the invention provides a method for monitoring food consumption in a subject, comprising: receiving and storing food data comprising nutrients and/or calories contained in one or more food item served to the subject; detecting the initiation of food consumption by the subject; obtaining real-time food consumption data; processing the food data and the real-time food consumption data to calculate food analysis data including a total amount of one or more nutrient and/or calories consumed by the subject.

In various embodiments, the food consumption data is obtained by measuring a change of weight; a change of volume; a change in the amount of a detectable label present in the food item; or mouthfuls of food taken by the subject. In some embodiments, the food consumption data is obtained by detecting a change in weight in one or more food item served to the subject as it is consumed by the subject.

In some embodiments, the method further comprises comprising receiving and storing data concerning the weights of utensils and food vessels used to serve one or more food items, and utilizing said data to correct for changes in weight due to movement of said utensils and/or food vessels in the calculation of food consumption data.

In some embodiments of the method, the initiation of food consumption signals the start of a clock, such that the time of each food consumption measurement may be tracked and recorded. In some embodiments of the method, one or more timers are set for predetermined periods of time following the ingestion by the subject of one or more medication, so that the subject is provided with a message warning against the consumption of food items containing certain nutrients during the predetermined periods of time from taking certain medications, if said nutrients are known to have certain interactions with said medications. In some embodiments, the methods of the invention further comprise receiving and storing data concerning consumption goals for one or more nutritional component, and utilizing said data in combination with the consumption analysis data to calculate progress towards the goal.

In some embodiments, a weight reading is made each time a change in weight in one or more food item served to the subject is detected. In some embodiments, a weight reading is made of one or more food item at defined time intervals.

In some embodiments of the method, an initial dose of insulin is provided to the subject upon initiation of food consumption.

In some embodiments, the method further comprises displaying real-time food consumption data to and/or the total amount of one or more nutrient and/or calories consumed by the subject. In some embodiments, the method further comprises displaying progress towards a consumption goal for one or more nutritional component. In some embodiments, the method comprises displaying a message or sending a signal when a predetermined amount of a nutrient has been consumed by the subject. In some embodiments, the method further comprising providing eating advice to the subject based upon one or more of the real-time consumption data, the consumption analysis data, or the progress towards a consumption goal for one or more nutritional component.

In some embodiments, the method further comprises sending information or instructions to a control device. In some embodiments, the control device is a drug delivery system which delivers a drug to the subject based upon the amount of one or more nutrients consumed by the subject. In some embodiments, the drug delivery system delivers insulin to the subject based upon the amount of carbohydrates consumed by the subject. In some embodiments, the control device provides information to a decision maker or to a data base.

The invention further provides a method of assisting a subject in meeting a nutritional goal, comprising: receiving and storing data comprising consumption targets for one or more nutritional components; receiving and storing food data comprising nutritional components contained in one or more food item served to the subject; detecting the initiation of food consumption by the subject; obtaining real-time food consumption data; processing the food data and the real-time food consumption data to calculate a total amount of one or more nutritional components consumed by the subject, and processing the consumption target data to calculate progress towards the consumption target for one or more nutritional components; and displaying progress towards the consumption targets for said one or more nutritional components. In some embodiments, the method further comprises providing a message to the subject based upon progress towards the consumption targets for said one or more nutritional components.

The invention further provides a method of managing blood glucose levels of a subject having diabetes, comprising: receiving and storing food data comprising carbohydrates contained in one or more food item served to the subject; detecting the initiation of food consumption by the subject; administering to the subject a dose of insulin equivalent to the cephalic phase of insulin secretion; obtaining real-time food consumption data; processing the food data and the real-time food consumption data to calculate a total amount of carbohydrates consumed by the subject; and administering a dose insulin to the subject each time a defined amount of carbohydrates is consumed by the subject.

The invention further provides for the use of any of the systems and methods of the invention to assist a subject in meeting nutritional consumption goals for one or more nutritional component selected from calories, carbohydrates, protein, fat, saturated fat, unsaturated fat, a mineral, a vitamin, an amino acid, a lipid, fiber, alcohol, caffeine or other food component.

The invention further provides for the use of any of the systems and methods of the invention in the treatment or clinical management of a subject having a condition including but not limited to liver disease, heart disease or heart failure, kidney disease or kidney failure, pancreatic disease, diabetes, hypertension, hyperlipidemia, hypercholesterolemia, Meniere's disease, an inborn disorder of metabolism, obesity and a food allergy or intolerance.

### BRIEF DESCRIPTION OF THE FIGURES

FIG. 1 schematically shows an embodiment of a food monitoring system of the invention.

FIG. 2 is shows an embodiment of a registration system of the invention.

FIG. 3 shows an embodiment of a data intake system of the invention, which is a smart tray.

FIG. 4 shows an embodiment of an initiation system, which is an initiation ring surrounding a set of utensils.

FIG. 5 schematically shows an embodiment of a tracking and analysis system of the invention.

FIG. 6 schematically shows an embodiment of a method of the invention for monitoring food consumption.

FIG. 7 is a programming flow diagram illustrating a graphical user interface for a smart tray embodiment of the invention.

FIG. 8 is a screen shot of a simulation of a smart tray embodiment of the invention, showing the tray ready for use.

FIG. 9 is a screen shot screen shot of a simulation of a smart tray embodiment of the invention, showing a menu for food item selection.

FIG. 10 is a screen shot of a simulation of a smart tray embodiment of the invention, showing the assignment of food items to load cells on the smart tray.

FIG. 11 is a screen shot of a simulation of a smart tray embodiment of the invention, showing a display of real time nutritional information.

### DETAILED DESCRIPTION OF THE INVENTION

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Further, the connecting lines and/or associated graphics shown in the various figures contained herein are intended to represent exemplary functional relationships and/or physical couplings between the various elements. It should be noted that many alternative or additional functional relationships or physical connections may be present in a practical system.

While the description references specific technologies, system architectures and data management techniques, the skilled artisan will appreciate that this description is of only certain embodiments and that other devices and/or methods may be implemented without departing from the scope of the invention. Similarly, while the description references a user interacting with the system via a personal computer user interface, the skilled artisan will appreciate that other interfaces may include but are not limited to mobile devices, cellular phones, medical devices such as drug delivery systems, kiosks, and handheld devices such as personal digital assistants as well as dedicated “smart tray” embodiments.

In general, the systems of the invention facilitate real-time monitoring (i.e., while eating is taking place) of food intake by a subject.

“Intake information” includes, for example, the amount of food consumed (e.g., in grams and/or calories) broken down by nutritional content of the food (e.g., grams of carbohydrates, protein, fat, saturated fat, essential amino acids, minerals and vitamins consumed), the time the subject consumes the food, food consumption rate, changes in food consumption rate, and the like.

A “food item”, as used herein, refers to any food or drink that may be consumed by a subject.

A “nutrient”, as used herein, may refer to a macronutrient (e.g., carbohydrate, protein, fat, including saturated and unsaturated fat as well as the specific type of fat, e.g. omega 3 fatty acids, fish oil), a vitamin (e.g., vitamin A, thiamine, riboflavin, niacin, pantothenic acid, pyridoxine, biotin, folic acid, vitamin B12, vitamin C, vitamin D, vitamin E, vitamin K, etc.), a mineral (e.g., sodium, potassium, calcium, magnesium, phosphorus, sulfur, etc.), an amino acid, a lipid (e.g., cholesterol), or other food component (e.g., fiber, alcohol, caffeine, antioxidant).

A “nutritional component”, as used herein, may refer to any of the nutrients described above, or to calories.

“Nutrient information” for a food item may include information concerning the amount of any nutrient and/or calories contained in a portion of the food item, typically expressed as nutrient or calories present per a given weight of the food item.

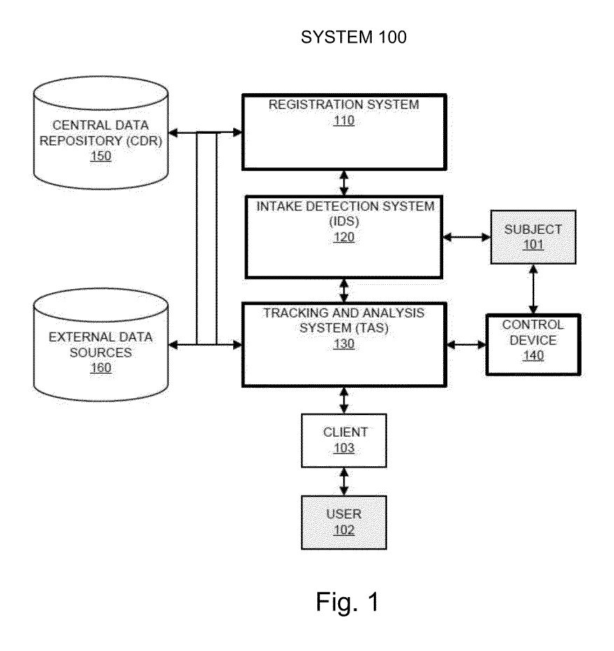

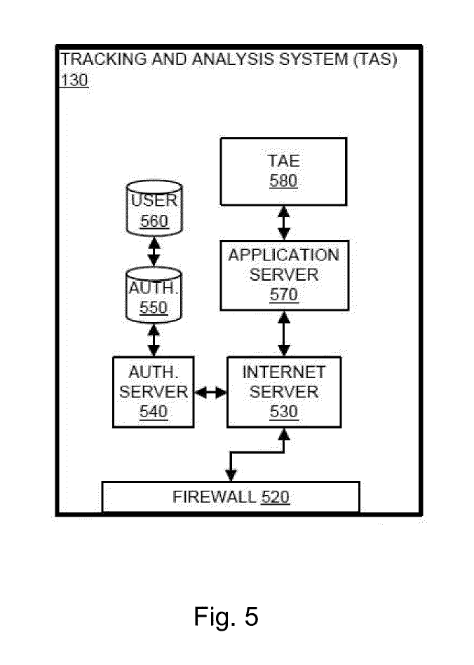

Exemplary embodiments of systems of the invention (as shown, for example, in FIG. 1 and FIG. 5) depict databases, including, for example, an authentication database, a user database, a central data repository, external database sources, and/or other databases that aid in the functioning of the systems of the invention. As those skilled in the art will appreciate, while depicted as separate and/or independent entities for the purpose of illustration, databases comprised within the systems of the invention may represent multiple hardware, software, database, data structure, and networking components, Furthermore, embodiments are not limited to the exemplary databases described herein, nor do embodiments necessarily utilize each of the disclosed exemplary databases.

Any “databases” discussed herein may include relational, hierarchical, graphical, or object oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), electronic medical records databases, such as those available from Cerner (Kansas City, Mo.), GE (Fairfield, Conn.), Epic (Verone, Wis.), or Intermountain Healthcare (Salt Lake City, Utah) or any other suitable database product.

The databases may be organized in any suitable manner, for example, as data files or lookup tables. Each record may be a single file, a series of files, a linked series of data fields, or any other data structure. Association of certain data may be accomplished through any suitable data association technique known or practiced in the art. For example, the data association may be accomplished either manually or automatically. Automatic association techniques may include, for example, a database search, a database merge, GREP, AGREP, SQL, using a key field in tables to speed searches, sequential searches through all tables and files, sorting records in a file according to a known order to simplify lookup, and/or the like. The association step may be accomplished by a database merge function, for example, using a “key field” in pre-selected databases or data sectors. Various database tuning steps may be used to optimize data performance. For example, frequently used files such as indexes may be placed in separate files in order to reduce In/Out (I/O) bottlenecks.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard hyper-text markup language (HTML) documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and/or an internet protocol (IP) address. The web server retrieves the appropriate web pages and send the data or applications for the web pages to the URL or IP address. Web services are applications that are capable of interacting with other applications over a communications means, such as the Internet. Web services are typically based on standards or protocols such as XML, SOAP, WSDL and UDDI. Web service methods are well known in the art, and are covered in many standard texts. See, e.g., Alex Nghiem, IT Web Services: A Roadmap for the Enterprise, Prentice Hall PTR, Upper Saddle River, N.J., 2003.

### Systems and Methods of the Invention

The invention provides systems for monitoring the food consumption of a subject. In an embodiment, as illustrated in FIG. 1, the system 100 comprises a registration system 110 configured to receive food data comprising nutrient information related to one or more food item served to a subject 101, an intake detection system 120 that detects consumption of food by subject 101, thereby generating real-time food consumption data, and a tracking and analysis system 130 configured to receive food data from registration system 110 and consumption data from said intake detection system 120 and to utilize the food data and the consumption data to calculate a total amount of one or more nutrient and/or calories consumed by the subject.

Subject 101 may be any human or animal that engages in consuming food and/or drink. For example, subject 101 may be a human patient who is served food from a component of intake detection system 120 (for example, a food tray) that monitors and tracks the patient's consumption of food. In some cases, subject 101 may be an animal whose food consumption is being monitored and tracked, for example, during the course of veterinary care or an animal research study.

The system 100 provides food consumption information to a user 102. User 102 may include any person, group, device, software, hardware, organization, company and/or the like that may monitor, evaluate, diagnose, analyze and/or report food intake information. In some embodiments, the system provides food consumption information to subject 101, for example, a signal or message when a defined amount of calories or of a particular nutrient has been consumed.

In some embodiments, user 102 is provided information via a client 103. Client 103 comprises any hardware and/or software suitably configured to facilitate requesting, retrieving, updating, analyzing, entering, and/or modifying data. The data may include intake information, subject (patient) information, device or control data, content, verification data, authentication data, demographic data, transaction data, or any information discussed herein. Client 103 includes any device (e.g., personal computer, mobile phone, etc.) that communicates (in any manner discussed herein) with tracking and analysis system 130 via any network disclosed herein.

In some embodiments, system 100 comprises a control device 140 operably connected to tracking and analysis system 130. Control device 140 may comprise any hardware and/or software suitably configured to receive data, instructions, information or signals from intake detection system 120, and/or tracking and analysis system 130. For example, control device 140 may be a drug delivery device or system (e.g., an intravenous system, insulin pump, etc.) that receives control information and/or instructions as input and administers a drug to subject 101. In some embodiments, control device 140 may also read, detect, or receive data from subject 101 and communicate that data to other system 100 components (e.g. tracking and analysis system 130).

In some embodiments, system 100 comprises a central data repository 150 operably connected with registration system 110 and/or tracking and analysis system 130. Central data repository 150 is a data repository that is configured to store a wide variety of comprehensive data for tracking, charting, monitoring, and/or reporting medical, dietary, or intake information. For example, central data repository 150 may comprise databases and data management software for patient medical records. In an embodiment, central data repository tracks and stores all the data associated with intake detection system 120 and tracking and analysis system 130, such as, for example, individual data readings of a subject 101's food intake.

In some embodiments, system 100 comprises one or more external data sources 160 operably connected with registration system 110 and/or tracking and analysis system 130. External data sources 160 may be any data sources that are accessible by system 100, and its various components, to provide reference, research, vendor and/or statistical data. For example, an external data source 160 may be a reference database with information on the nutritional content of various foods and beverages. In a further example, external data source 160 may be a vendor database that correlates food identifier data (e.g., identifier 210) with food amount and nutritional content data. While depicted as a single logical entity in FIG. 1, those of skill in the art will appreciate that external data source 160 may, in some embodiments, consist of multiple physical and/or logical data sources.

In various embodiments, system 100 may comprise a control device 140, a central data repository 150, and one or more external data sources 160 as shown in FIG. 1, or may comprise any one or more of these elements.

Registration system 110 may comprise any hardware and/or software suitably configured to facilitate reading, registering, importing, retrieving, updating, analyzing, entering, and/or modifying data regarding food, nutritional content, patients, food sources, food statistics, or the like.

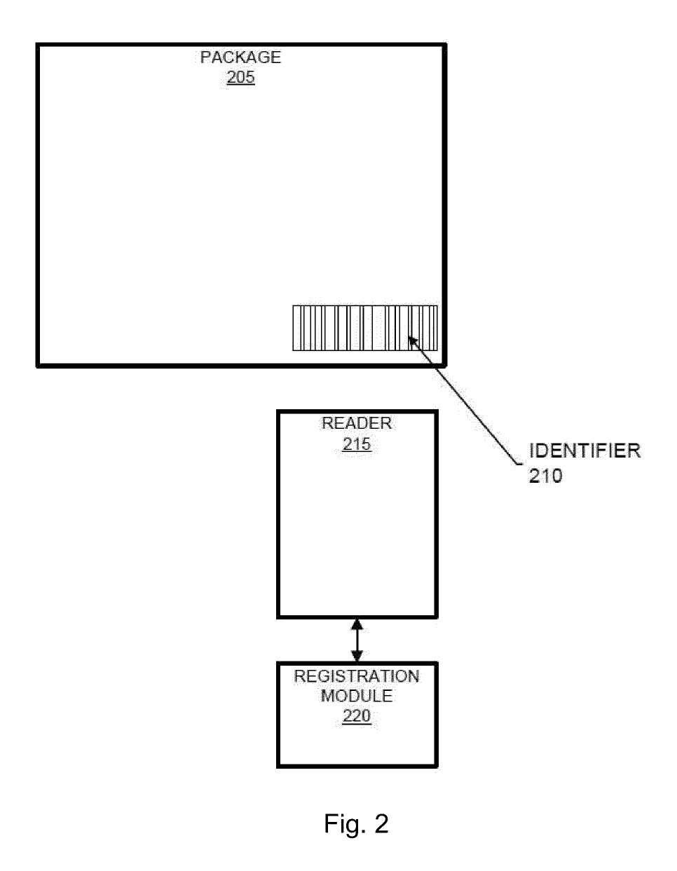

In some embodiments, registration system 110 comprises a data identifier, entry components, and data components that facilitate gathering information. In one embodiment, as shown in FIG. 2, a package 205 containing a food product comprises an identifier 210 that identifies the contents of package 205. Identifier 210 may comprise a code, an account, a barcode, a radiofrequency identification (RFID) tag, a biometric, a magnetic stripe, a symbol, a graphic, or the like. Reader 215 may be configured to interact directly with central data repository 150 or with a registration module 220. Registration module 220 may comprise any hardware or software configured to receive data from reader 215, to process, format, convert and/or analyze the data, and to communicate with other components of system 100, such as central data repository 150. In an embodiment, a menu is configured with a plurality of identifier 210s and reader 215 may read the identifier on the menu corresponding to various foods. In some embodiments, the name of a food item or an identifier is manually entered, for example, into a data interface using a keyboard. In some embodiments, the registration system provides a menu of food items, for example, as a display on a data interface, and a food item is selected from the menu, for example, using keyboard, a mouse, or a touch screen.

In other embodiments, an identifier 210 is added by a user to a food item when a portion of the food item is prepared to be served to a subject. In a non-limiting example, the identifier is a “flag,” such as a RFID tag attached to a plastic toothpick, that is placed in the food or onto a vessel containing the food.

In some embodiments, registration system 110 obtains food data using machine vision and/or image analysis methods, for example by reading a barcode or data matrix attached to a food item or a container comprising a food item, or by visually recognizing a type of food served and looking up nutritional information about that food from a database.

Registration system 110 may acquire further information regarding food content from one or more external data sources 160 and/or from central data repository 150. External data sources may include data from, for example, Pennington, J., Church, H., Food Values of Portions Commonly Used, Harper and Row, N.Y., 1989 or the U.S. Department of Agriculture National Nutrient Database, or any other database or other source of nutrient information (e.g., choosemyplate.gov or CalorieKing.com).

In an embodiment, identifier 210 encodes the food nutrient information, thus reducing or eliminating reliance on external databases.

In some embodiments, registration system 110 is configured to establish baseline data for intake detection system 120. For example, the type, weight and other characteristics of utensils and food vessels (e.g., bowl, cup, plate and the like) may be entered into registration system 110 to aid in the detection of weight variations that occur during food consumption. In this way, intake detection system 120 is able to distinguish the presence or absence of, for example, a fork that is placed on a food vessel, without confusing the presence or absence of the fork with the presence or absence of food. In some embodiments, registration system 110 is configured to allow entry of additional food data after the initiation of food consumption has begun, for example, when additional food is added to a food vessel.

Intake detection system 120 may comprise any apparatus, hardware and/or software suitably configured to facilitate detecting, distributing, signaling, timing, measuring and/or calculating content (e.g., food) and changes in content levels. In some embodiments, intake detection system 120 comprises one or more sensing device configured to detect a change of weight of one or more food item served to subject 101. In various embodiments, intake detection system 120 comprises one or more scale, weighing device, or other device operable to measure mass and/or weight (for example, a load cell, a spring balance, a hydraulic scale, a fluid or gas-filled bladder, or any combination thereof).

While embodiments of the invention described in detail below monitor food consumption by detecting changes in weight of food items, the invention also contemplates alternative methods of detecting food consumption, for example, by monitoring changes in food volume or number of mouthfuls of food consumed, for example by monitoring the movements of a utensil to the subject's mouth using a motion-sensing camera, a motion sensor comprised within a utensil (see, for example, U.S. Application No. 2010/0109876) or by using an intraoral sensor (see, for example, U.S. Pat. No. 7,610,919). In some embodiments, each of one or more food items served to the subject is labeled with an edible powder comprising a detectable label, and the intake detection system comprises one or more sensors configured to detect the amount of label remaining in each food item. Labels may include elements, such as iron, calcium, sodium, potassium, copper, chloride, magnesium, phosphorus, iodine, or specific isotopes of these elements; vitamins; or carbohydrates, proteins or lipids which could be used to encapsulate a nutrient. Methods of detecting and measuring such labels may include, for example, infrared, ultrasound or nuclear magnetic resonance.

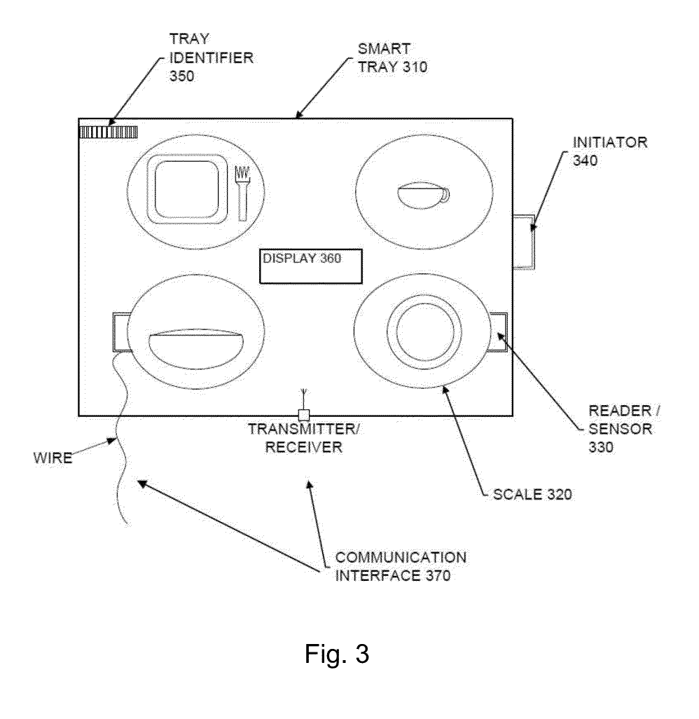

In an embodiment, as shown in FIG. 3, intake detection system 120 comprises a smart tray 310. In the embodiment illustrated in FIG. 3, the smart tray comprises one or more scales 320 and one or more readers/sensors 330. Scale 320 is operably connected to reader/sensor 330 such that reader/sensor 330 receives or acquires data from scale 320. In some embodiments, a reader sensor 330 is operably connected to more than one scale 320. Scale 320 may comprise any scale, weighing device, or other device operable to measure mass and/or weight (for example, a load cell, a spring balance, a hydraulic scale, a fluid or gas-filled bladder, or any combination thereof). Reader/sensor 330 may comprise a processor or circuitry operable to receive data, poll for data, detect variations in scales 320 or other sensors 330, perform calculations, run software modules, track and record time (e.g., a clock) and/or to perform other functions enabling gathering of data and statistics regarding input from scale 320.

In some embodiments, intake detection system 120 comprises a plurality of scales 320 and a plurality of reader/sensors 330 that track and record data from discrete regions of smart tray 310. In some embodiments, intake detection system 120 or smart tray 310 comprises a single scale operable to determine a weight measurement and differential changes in weight from multiple discrete regions of the tray.

In some embodiments, smart tray 310 is a tray-like platform, similar to that of a standard meal service tray, although other shapes and configurations, such as flat trays, plate-like or bowl-like serving platforms, or glass-like or cup-like serving platforms (for monitoring liquid consumption), are also possible. Smart tray 310 may comprise one or more independent scales. Each scale may be connected to one or more vessels such as plates, containers, glasses, bottles, bowls, jars, skewers or packages. Each vessel may contain one or more discrete food items such as entrees, servings, portions, beverage or meals. Each scale may also be electronically connected, with or without wires, to an electronic database that contains specific nutritional information for each discrete food item being served.

While FIG. 3 depicts an embodiment in which the weighing devices are comprised in a tray upon which food items are served, other configurations are also possible. For example, the data intake system of the invention may comprise one or more utensil (such as a spoon, fork, spork, chopsticks, or combination thereof) having a built-in scale. In some embodiments, the utensil is configured to communication, for example, by wireless communication) with a device that knows the location and identity of each food item (i.e. it knows that a plate in the upper right hand corner of a serving tray contains mashed potatoes, the plate in the center contains turkey with stuffing, etc.). The device monitors the tray area to determine the discrete region (i.e., the plate) where the utensil is used, and the utensil sends the device the measured weights of food as the food is removed from that region. In some embodiments, the device is comprised within a smart tray as in FIG. 3, save that the tray need not comprise the scales 320.

In various embodiments, smart tray 310 may further comprise one or more of an initiator 340, a tray identifier 350, a display 360 and a communication interface 370. In some embodiments, smart tray 310 further comprises a memory configured to store tracking, measurement, and/or nutritional data. In various embodiments, these components are operably associated with, connected, or attached to one another to comprise the smart tray 310.

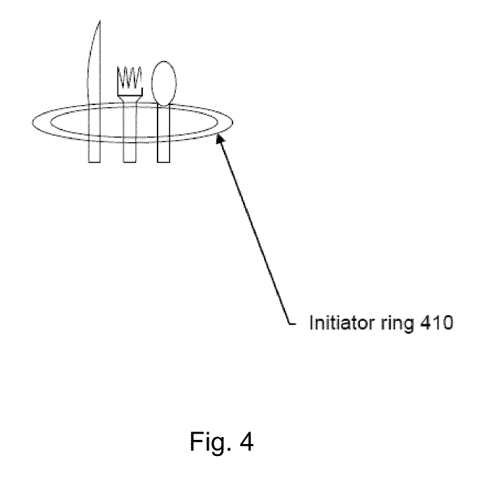

Initiator 340 may comprise a button, switch, an optical, electric, biometric or mechanical sensor, a reader, or a receiver operable to receive an indication that smart tray 310 is, or is about to be, placed into operation. In some embodiments, initiator 340, or a subset of its functionality, may be a device that is not physically attached to smart tray 310. For example, in an embodiment shown in FIG. 4, initiator ring 410 is a band configured to bind utensils together, and configured to signal smart tray 310 (e.g., via communications interface 370) when the band is detached from the utensils or broken.

Tray identifier 350 may comprise a code, an account, a barcode, a RFID tag, a biometric tag, a magnetic stripe, a symbol, a graphic, or the like. In an embodiment, tray identifier 350 may encode food, food content, patient, hospital, supplier, manufacturer, pharmaceutical or other information. In an embodiment, registration system 110 is configured to read tray identifier 350 during a food registration or baselining process.

Display 360 may comprise any static or dynamic display configured to communicate information to subject 101 or user 102. In an embodiment, display 360 comprises a digital display of the information encoded in tray identifier 350, and/or a display of the data measured by scale 320 and/or sensed or calculated by reader/sensor 330. Display 360 may be operable to receive data from scale 320, reader/sensor 330, communication interface 370, and/or tracking and analysis system 130.

Tracking and analysis system 130 is suitably configured to enable tracking, monitoring, analysis, reporting and/or coordination of intake information received from intake detection system 120 and/or registration system 110. In some embodiments, tracking and analysis system 130 provides control signals or recommendation data to control device 140, subject 101 and/or user 102. In some embodiments, tracking and analysis system 130 comprises a processor operable to receive food data from registration system 110 and food consumption data from tracking and analysis system 120, and to utilize the food data and the consumption data to calculate a total amount of one or more nutrients and/or calories consumed by a subject.

In some embodiments, tracking and analysis system 130 comprises or is operably connected to a processor or software module programmed to generate a message based upon the data received and analyzed by tracking and analysis system 130, such that system 100 may provide eating advice to subject 101 to assist subject 101 in regulating food consumption. For example, if tracking and analysis system 130 detects that calories are being consumed at a rate exceeding a defined limit, a message is conveyed that may read “you are eating too fast.” If no food consumption is detected during a defined time period, a message is conveyed that may read “are you done eating?” If tracking and analysis system 130 detects that additional food has been added to the system while a subject is eating, a message is conveyed that may read “did you take another serving?” The eating advice may be provided, for example, as messages on a display, or as voice messages from a speaker.

In an embodiment, shown in FIG. 5, tracking and analysis system 130 comprises firewall 520, internet server 530, authentication server 540, authentication database 550, user database 560, application server 570 and tracking and analysis engine 580.

Firewall 520 may comprise any hardware and/or software suitably configured to protect tracking and analysis system 130 from users of other networks. Firewall 520 may reside in various configurations including but not limited to stateful inspection (also known as dynamic packet filtering), proxy based, and packet filtering. In various embodiments, firewall 520 may be integrated as software within internet server 530, within any other system 100 component. In other embodiments, firewall 520 may reside within another computing device or may take the form of a standalone hardware component.

Authentication server 540 may include any hardware and/or software suitably configured to receive authentication credentials, encrypt and decrypt credentials, authenticate credentials, and/or grant access rights according to pre-defined privileges attached to the credentials. Authentication serve 540 may grant varying degrees of application and data level access to users based on information stored within authentication database 550 and user database 560. Authentication database 550 may store information used in the authentication process such as, for example, user identifiers, passwords, access privileges, user preferences, user statistics, and the like. User database 560 maintains user information and credentials for users 102. Application server 570 may include any hardware and/or software suitably configured to serve applications and data to a connected client 103.

Tracking and analysis engine 580 is a software module (or plurality of software modules) configured to enable online functions including but not limited to: receiving user input; configuring responses; dynamically configuring user interfaces; formatting web pages (or portions thereof); requesting, receiving, updating, creating and/or displaying data; accessing external functions, applications, or data; verifying user responses; authenticating the user; initiating processes; initiating other software modules; and encrypting and/or decrypting. In some embodiments, tracking and analysis engine 580 interacts with registration system 110, intake detection system 120, and control device 140.

Additionally, tracking and analysis system 580 may include any hardware and/or software suitably configured to receive requests from client 103 via Internet server 530 and application server 540. Tracking and analysis system 580 is further configured to process requests, execute transactions, construct database queries, and/or execute queries against databases and other data sources within system 100 (e.g., central data repository 150), external databases, and/or temporary databases.

Tracking and analysis engine 580 is configured to exchange data with other systems and application modules. In an embodiment, tracking and analysis engine 580 is configured to interact with other system 100 components to perform complex calculations, retrieve additional data, format data into reports, create XML representations of data, construct markup language documents, construct, define or control user interfaces, and/or the like. Tracking and analysis engine 580 may reside as a standalone system or may be incorporated with the application server 570 or any other tracking and analysis system 130 component as program code. As one of ordinary skill in the art will appreciate, tracking and analysis engine 580 may be logically or physically divided into various subcomponents such as a workflow engine configured to evaluate predefined rules and to automate processes.

Any of the components described herein, including system 100, registration system 110, intake detection system 120, tracking and analysis system 130, and control device 140, may further include one or more of the following: a host server or other computer system including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and one or more databases.

In some embodiments of the invention, system 100 is a “standalone” smart tray, which comprises the functions of registration system 110, intake detection system 120, and tracking and analysis system 130. In some embodiments, this standalone tray further comprises one or more databases containing nutritional information for a number of food items, and/or means to display food intake information and food consumption information analyzed to determine nutrient and calorie consumption. In other embodiments, system 100 comprises a smart tray 310 as intake detection system 120, while registration system 110 and tracking and analysis system 130 are comprised within one or more separate devices, such as a personal computer, smart phone or tablet, and are linked to the smart tray by a wired or wireless connection.

In various embodiments, the smart tray comprises a circuit board that performs any one or more of the following functions: wireless communication between tray and input/output device (e.g. smart phone, computer, tablet); charger; power regulator; CPU processor; analog to digital converter; operational amplifier; tracking and recording time (e.g., a clock); encryption; firm wire; and battery.

The systems and methods of the invention proceed on the assumption that the removal of food from system 100 (e.g., from a food tray or other serving platform comprised within system 100) correlates to the consumption of this food. In some circumstances this may be an inaccurate assumption, since the subject may remove the food from the serving platform but not consume it, or may consume additional food that was not served. In some embodiments, the system may further comprise means for detecting the movement of the subject's arm to the subject's mouth, for example, a motion sensitive camera (e.g., Microsoft Kinect) that is able to detect and track such motions. Such means may be used to provide further information when the condition of a subject (e.g., weight gain) is not consistent with the food consumption information recorded by system 100.

As will be appreciated by one of ordinary skill in the art, one or more system 100 components may be embodied as a customization of an existing system, an add-on product, upgraded software, a standalone system (e.g., a kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a tangible computer-readable storage medium having computer-readable program code embodied in the storage medium, which when executed by a computer performs any of the functions discussed herein. Any suitable computer-readable storage medium may be utilized, including hard disks, cache memory, CD-ROMs, optical storage devices, magnetic storage devices, and the like.

Client 103 may include an operating system (e.g., Windows XP, Windows NT, 95/95, 2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 103 may be in any environment with access to any network, including both wireless and wired network connections. In some embodiments, access is through a network or the Internet through a commercially-available web-browser software package. Client 103 components may be independently, separately, or collectively suitably coupled to the network via data links. Data links include for example, a connection to an Internet Service Provider (ISP) over the local loop as is typically used in connection with standard wireless communications networks and/or methods, modem communication, a cable modem, a Dish network, ISDN, or a Digital Subscriber Line (DSL). See, e.g., Gilbert Held, Understanding Data Communications, 7^{th} ed., Addison-Wesley Professional, 2002. In some embodiments, any portion of client 103 is partially or fully connected to a network using a wired (“hard wire”) connection. As those skilled in the art will appreciate, client 103 and/or any of the components of system 100 may include wired and/or wireless components.

Internet server 530 may be configured to transmit data to client 103 within markup language documents. “Data” includes but is not limited to information such as commands, transaction requests, queries, files, content, user content, data for storage, and/or the like in digital or any other form. Internet server 530 may operate as a single entity in a single geographic location or as separate computing components located together or in separate geographic locations. Further, Internet server 530 may provide a suitable web site or other Internet-based graphical user interface, which is accessible by users. In some embodiments, the Microsoft Internet Information Server (IIS), Microsoft Transaction Server (MTS), and Microsoft SQL Server are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

As with Internet server 530, application server 570 may communicate with any number of other servers, databases, and/or components through any means known in the art. Further, application server 570 may serve as a conduit between client 103 and the various systems and components of system 100. Internet server 530 may interface with application server 570 through any means known in the art including, for example, a LAN/WAN. Application server 570 may further invoke software modules such as tracking and analysis engine 580 in response to user 101 requests.

One skilled in the art will appreciate that, for security reasons, any databases, systems, devices, servers, or other components of system 100 may consist of any combination thereof at a single location or at multiple locations, wherein each database or system includes any of various suitable security features, such as firewalls, access codes, encryption, decryption, compression, decompression, and/or the like.

The systems and methods of the invention may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language including but not limited to C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML), with the various algorithms being implemented with any combination of data structures, objects, processes, routines, or other programming elements. Further, systems of the invention may employ any number of conventional techniques for data transmission, signaling, data processing, network control, and the like. Systems of the invention may further employ a client-side scripting language, such as JavaScript, VBScript, or the like, to detect or prevent security issues. For a basic introduction to cryptography and network security, see Bruce Schneier, Applied Cryptography: Protocols, Algorithms and Source Code in C, 2^{nd} ed., John Wiley and Sons, 1995; Jonathan Knudson, Java Cryptography, O'Reilly and Associates, 1998; William Stallings, Cryptography & Network Security: Principles & Practice, Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart or blocks. These computer program instructions may also be stored in a computer-readable memory that can direct a computer or other programmable data processing apparatus to function in a particular manner, such that the instructions stored in the computer-readable memory produce an article of manufacture including instruction means which implement the functions specified in the flowchart or blocks. The computer program instructions may also be loaded onto a computer or other programmable data processing apparatus to cause a series of operational steps to be performed on the computer or other programmable data processing apparatus to produce a computer-implemented process such that the instructions which execute on the computer or other programmable apparatus provide steps for implementing the functions specified in the flowchart or blocks.

Accordingly, functional blocks of the block diagrams and flowchart illustrations support combinations of means for performing the specified functions, combinations of steps for performing the specified functions, and program instruction means for performing the specified functions. It will also be understood by one of skill in the art that each functional block of the block diagrams and flowchart illustrations, and combinations of blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Those of skill in the art will appreciate that the illustrated steps described herein may be comprised in any number of configurations including the use of windows, web pages, web forms, pop-up windows, prompts, and/or the like. It will be further appreciated that the multiple steps as illustrated and described may be combined into single web pages and/or windows but have been expanded for the sake of simplicity. In other cases, steps illustrated and described as single process steps may be separated into multiple web pages and/or windows, but have been combined for simplicity.

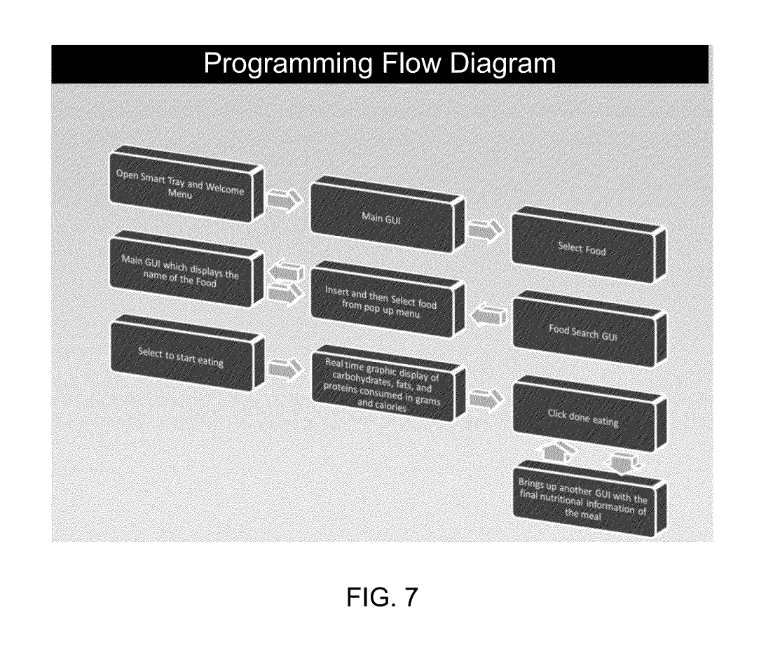

FIG. 7 is a programming flow diagram illustrating a graphical user interface (GUI) for a smart tray embodiment of the invention. In the embodiment illustrated in the diagram, the user interface provides an open and welcome menu, from which the user may proceed to the main GUI. The interface further provides a food search GUI, which allows the user to select and enter foods from a popup menu. The user selects start eating (for example, by clicking an icon on the GUI), and the interface provides a real time graphic display of carbohydrates, fat, and protein consumption in grams, as well as calorie consumption. The user indicates eating is done (for example, by clicking an icon on the GUI), and the interface provides another screen which shows the final nutritional information for the meal.

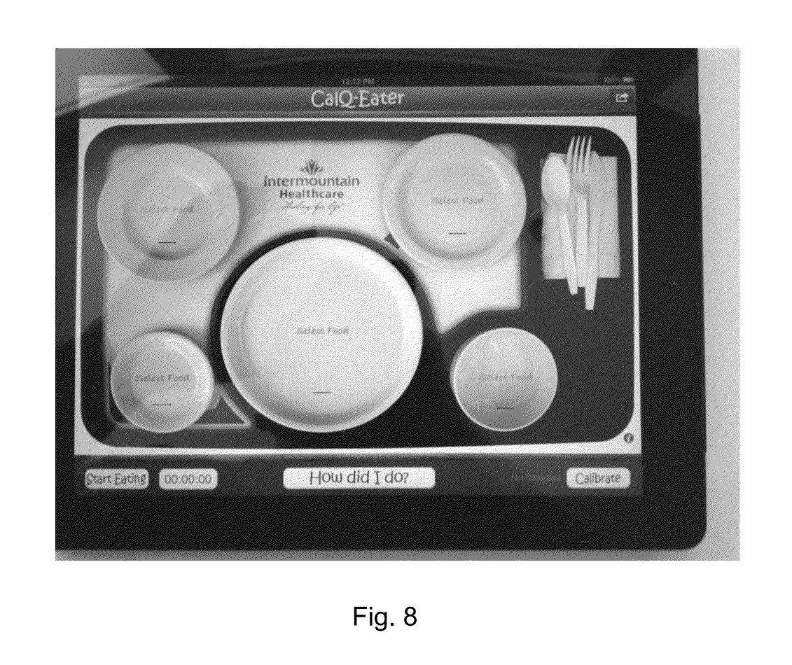

This process is further illustrated in FIGS. 8-11, which show a simulation of the operation of a smart tray embodiment of the invention. FIG. 8 is a screen shot of a simulation of a smart tray embodiment of the invention, showing the tray ready for use. In the embodiment illustrated in FIG. 8, the tray comprises five discrete regions for different foods and beverages, each with a serving vessel, as well as a region for utensils. In the embodiment shown, the tray also provides a “Start Eating” button which signals the initiation of food consumption, and starts the timer shown next to the button. In the embodiment shown, the tray also provides a “Calibrate” button which signals the system to take baseline weight measurements of the food and/or food vessels. While the “start” and “calibrate” initiators are shown as buttons on the tray itself, in some embodiments these may be provided on a user interface operably connected to the tray, for example, as clickable icons on a display.

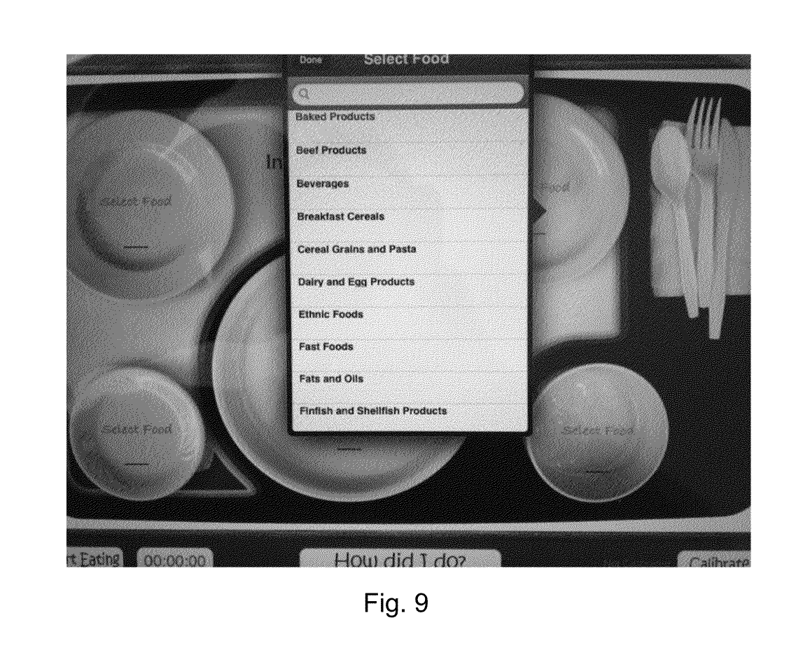

FIG. 9 is a screen shot screen shot of a simulation of a smart tray embodiment of the invention, showing a menu for food item selection. The user may select a food category from the pop-up menu, or may enter the name of a food in the search window.

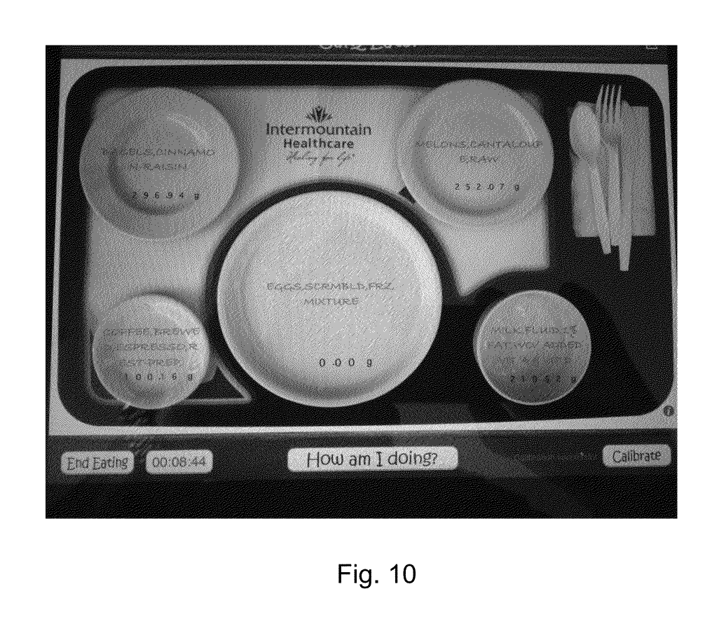

FIG. 10 is a screen shot of a simulation of a smart tray embodiment of the invention, showing the assignment of food items to each discrete region on the smart tray. The name of each food item is shown, as well as the current measured weight of each item.

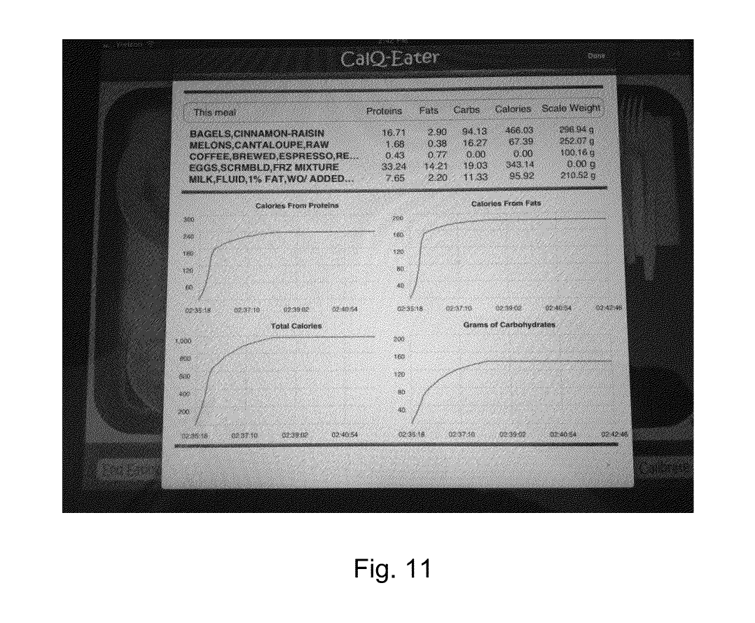

FIG. 11 is a screen shot of a simulation of a smart tray embodiment of the invention, showing a display of real time nutritional information. In this display, the food items that have currently been consumed in the meal are shown along with their protein, fat, carbohydrate, and caloric content, as well as the current scale weight remaining of each item. The display also provides graphs tracking calories from protein, calories from fats, total calories, and grams of carbohydrate consumed over the course of the meal.

In some embodiments of the invention, system 100 comprises a smart tray 310 as intake detection system 120, while registration system 110 and tracking and analysis system 130 are comprised within one or more separate devices, such as a personal computer, smart phone or tablet, and are linked to the smart tray by a wired or wireless connection. In one embodiment of the system of the invention, intake detection system 120 comprises a wireless smart tray, and registration system 110 and tracking and analysis system 130 are comprised within an Apple device (e.g., iPhone, iPod Touch, or iPad) that runs an iOS app. The iOS app allows use of the smart tray in combination with the separate device, which is used to input food data and display consumption data. A database within the app provides up-to-date nutritional information for over 800,000 different foods.

In this embodiment, the app includes an encrypted upload link, so that the subject or user can easily and securely share data. For example, the subject or user can automatically back up and upload daily results to a data center of choice, or share results with friends, family, coaches, trainers, doctors, nutritionists, or with an online fitness or nutritional community.

The tray is sized to fit within the confines of a standard flat table placemat, having dimensions of approximately 41 cm in width and 28 cm in height. In this embodiment, the tray comprises seven discrete serving areas. One of these serving areas is configured to receive a beverage glass. The other six areas are configured to receive food vessels. The surface of the tray is configured to provide two smaller regions that can accommodate single food vessels, each above a single load cell, and two larger regions that can accommodate either one larger food vessel above two load cells, or two small vessels each above one load cell, allowing for flexibility in serving sizes. The user is able to select whether the larger regions will contain one or two food vessels, so that the system will conduct one weight measurement over both load cells when a single large food vessel is used. There is also a region of the tray for eating utensils.

Seven load cells are each positioned underneath a serving area of the tray. The load cells are each connected to an integrated circuit board, a battery to the lower right of the circuit board, and an on/off switch and charger in the center of the top edge. The tray is composed of an injected molded plastic with water-tight silicone membranes over each load cell. The internal mechanisms of the tray (load cells, circuit board and battery) are mounted on a rigid piece of plastic to facilitate assembly and cleaning.

The starting screen of the app, as run on an Apple iPad, displays a visual of the tray. This screen allows the user to select each food serving area by clicking on the “Select” icon displayed within each serving area, and enter the type of food in each area by selecting from a displayed menu. The screen provides a “Start Eating” button which initiates recordation of consumption data. The “Show Progress” button allows the user to select displays showing real-time consumption data. The “Connect Tray” button tells the app to wirelessly connect to the tray. At the bottom of the screen, the app indicates that the tray is not yet connected. The run time of the consumption session is also shown, set at zero.

While the smart tray shown in this embodiment resembles a cafeteria tray with special dishes, other forms of the tray are also possible, including any of those described above. In an embodiment, the tray has a shape based upon the traditional three course Japanese sushi platform tray, being rectangular with rounded corners, and having an essentially flat surface lacking depressed serving areas. In this embodiment, the tray comprises three flat scale sensors. Each sensor comprises a chip that integrates simultaneous signals from a plurality of load cells. Each of the three flat scale sensors is shaped differently, so as to accommodate food vessels of different sizes and shapes. In this embodiment, the tray comprises a “Tare” button for each scale sensor, to enable each scale to be zeroed after placing an empty food vessel on the scale sensor. This allows for the use of any household food vessels, rather than requiring use of specifically designed food vessels.

In some embodiments, the smart tray comprises means to display food intake information and food consumption information analyzed to determine nutrient and calorie consumption, for example, a display such as an LCD screen. In some embodiments, the smart tray is a “standalone” system which further comprises the functions of registration system 110, intake detection system 120, and tracking and analysis system 130. In some embodiments, this standalone tray further comprises one or more databases containing nutritional information for a number of food items.

In embodiments where the smart tray comprises a display, the display may be located on any part of the tray. In some embodiments, the display is positioned on a region of the tray, for example an edge or corner, where it will not distract the subject while eating. In some embodiments, the tray further comprises a lid covering all or part of the tray, which folds up to allow use of the tray, and comprises a display screen on its inner surface.

In various embodiments, the tray is sized so as to fit within the dimensions of a typical table placemat. In an embodiment, the tray is about 40 cm or less by about 50 cm or less; about 35 cm or less by about 42 cm or less; or about 30 cm or less by about 36 cm or less. In various embodiments, the tray has a thickness of less than 3 cm, less than 2 cm, or less than 1 cm. In some embodiments, the tray is designed so that it may be placed into a more compact and portable configuration when not in use. In some embodiments, the tray is segmented into, for example, half, thirds, or quarters corresponding to the four quadrants of the tray. Each segment of the tray comprises one or more scale sensor. The segments of the tray may be partially separated from each other, or flexibly attached to each other, allowing the tray to fold. In some embodiments, the tray can be folded to dimensions suitable to allow it to fit within a pocket or handbag, for example, about 10 cm by 10 cm or smaller. In other embodiments, the tray is made from a flexible material so that it can be rolled up into a cylinder.

In the various embodiments described above, the weight of the tray may be less than about 2 kg; less than about 1 kg; or less than about 0.5 kg. In the various embodiments described above, the tray may be made of a waterproof plastic material. In various embodiments, the material of the tray is designed to be dishwasher safe, and configured so as to protect the internal circuitry of the tray.

The invention further provides methods of monitoring, in real-time, food consumption of a subject. A subject 101, who may be, for example, a patient in a hospital, is served food using a monitoring system of the invention, for example, on a smart tray 310. The subject's consumption of food, by time and by amount, weight, and nutritional content of the food, is detected by intake detection system 120 (in some embodiments, by smart tray 310) and is stored, analyzed, and/or used in real time to aid in diagnostic or therapeutic decisions. Thus in some embodiments the invention provides a method for monitoring food consumption in a subject, comprising: receiving and storing food data comprising nutrients and/or calories contained in one or more food item served to the subject; detecting the initiation of food consumption by the subject; obtaining real-time food consumption data; and processing the food data and the real-time food consumption data to calculate a total amount of one or more nutrient and/or calories consumed by the subject.

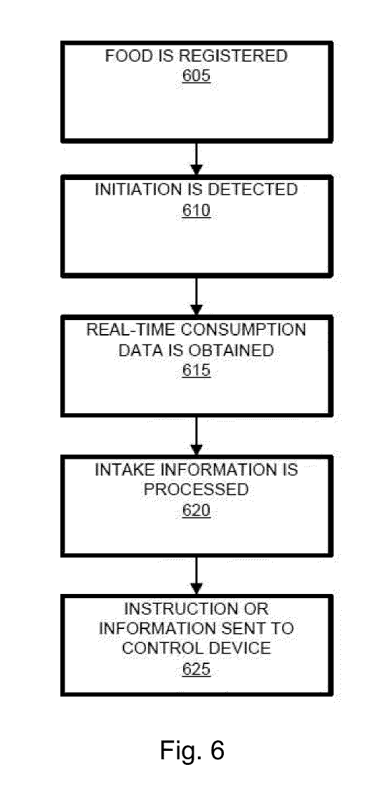

An embodiment of the method of the invention for monitoring food consumption is shown in FIG. 6. The initial type and/or amount of food served to the subject is registered in system 100 using registration system 110 (step 605). In some embodiments, a food item is identified manually or automatically and then weighed so that nutritional content can be calculated based upon known nutritional information for that food item that is stored in registration system 110 or retrieved from an external database 160. For example, in some embodiments, smart tray 310 weighs and calculates the nutritional information for an identified food item which has been placed on the tray. Methods to enter the identity of a food item may include manual entry or selection from a list of foods displayed by the system (for example, on the display 360 of a smart tray 310); use of a remote entry device similar to a remote control; or utilization of information transmitted from the food item's container, or from a flag placed into the food item, by a bar code or radio frequency chip.

In an embodiment, various containers 220 of food are encoded with identifiers 210, and a user 102 (e.g., a healthcare provider) reads or detects identifier 210 while apportioning the food from a container 220 to smart tray 310. Alternatively, identifiers 210 may be on a menu that lists various food items that may be served to the subject. Identifier 210 may be used to determine the amount, type, and nutritional content of the food item (e.g., by accessing an external data source 160). In some embodiments, identifier 210 indicates type of food and nutritional content, and the amount (e.g., the initial weight) of the food is measured by a scale 320 in response to the placement of the food on smart tray 320.

Identifier 210 may be read using any method or device known in the art that is suitable to read, acquire, or detect an identifier 210. For example, identifier 210 may be: an RFID tag that is read by an RFID reader; a bar code that is read by an optical scanner; a magnetic stripe, a biometric; or a human-read code that is read and entered manually by a user 102. In an embodiment, food identification data is acquired via tray identifier 350, which may include data regarding a plurality of food items, as well as positional information regarding where each item is placed on smart tray 310. Registration data may be initially stored in central data repository 150, or may be stored on a memory element in registration system 110 or smart tray 310.

Initiation of food consumption is detected and tracked (step 610). Initiation of food consumption may serve as a signal to start a timer or clock that tracks and records the time of each subsequent measurement of food intake. In some embodiments, tracking the initiation of food consumption enables enhanced data collection or enhanced diagnostic or therapeutic decision making. For example, in treating diabetes, it is desirable to anticipate the consumption of food by a subject 101 so that an initial dose of insulin can be administered to subject 101 prior to the food being consumed. In various embodiments, initiation can be signaled in a variety of ways. In an embodiment, an initiation signal is sent to tracking and analysis system 130 (or to smart tray 310) when a band holding eating utensils is broken for by subject 101. In other non-limiting embodiments, initiator 340 may be a button that is depressed, a sensor that detects a cover being removed from a smart tray, or a sensor that detects proximity to a subject 101 (e.g., by sensing an electronic signal in the subject's room, a biometric, or a tag attached to the patient). In an embodiment, initiation may be signaled by detection of a change in weight by a scale 320 that indicates that one or more utensils have been removed from a smart tray. In some embodiments, initiation may be signaled by selecting an option, clicking on a graphic, or otherwise entering information into a user interface that is comprised within a component of system 100 (for example, smart tray 310).

The initiation signal is communicated to tracking and analysis system 130. In some embodiments, tracking and analysis system 130 sends a signal to a control device 140 to take an action, such as administration of a dose of insulin to subject 101. In some embodiments, receipt of the initiation signal starts a tracking and analysis engine 580 tracking module that registers the initial baseline data (e.g., by storing a tracking record in central data repository 150).

As food is consumed, intake detection system 120 (in some embodiments, food tray 310) provides real-time food consumption data to tracking and analysis system 130 (step 615). In some embodiments, scale 320 weighs a food item in real-time (i.e., each time food is removed) or at defined time intervals, such as every 30 seconds, 1 minute, 5 minutes, or 10 minutes. In some embodiments, reader/sensor 330 senses a change in weight as indicated by scale 320 and takes a data reading. Tracking and analysis system 130 receives consumption data (for example, weight data) via communication interface 370 and records the data. In some embodiments, tracking and analysis system 130 may record differential weight data by subtracting a presently read weight from one or more prior weight measurements. In some embodiments a clock within intake detection system 120 records and tracks the time of each measurement. Alternatively or in addition, tracking and analysis system 130 may record and track the time when each data reading is received. Time may be recorded and tracked as actual time of day (and calendar date) and/or as time from the initiation of food consumption.

Food consumption information (intake information) is processed (step 620). Processing logic in tracking and analysis engine 580 may calculate the consumed nutritional components of each food item, such as calories, and grams of protein, carbohydrate, fat, saturated fat, essential amino acids, minerals and vitamins. In some embodiments, display 360 of a smart tray 310 shows intake information detected from scales 320.

In an embodiment, intake detection system 120 continuously monitors the change in weight of food content on smart tray 310 and displays a message or sends a signal when a defined amount of food, for example, 10 grams or 100 calories, has been consumed. In some embodiments, system 100 displays a message or sends a signal when a defined amount of a particular nutritional component (e.g., sodium, saturated fat, or calories) has been reached.

In some embodiments, system 100 assists a subject in monitoring nutritional intake in order to meet a nutritional goal, such as a body weight goal, a fitness goal, a training goal, or a nutrient consumption goal. For example, in order to assist in meeting a weight loss or gain goal, the subject may set a goal for total calories to be consumed over a given period (e.g., per meal, per day, per week). In some embodiments, the subject may set goals for one or more other nutritional components in addition to or in place of calories. For example, a runner training for a marathon may set a goal for total calories to be consumed over a given period, with specific percentages of these calories to be derived from carbohydrates, protein and fat. In various embodiments, the subject may set consumption goals for one or more of any nutritional component selected from calories, carbohydrates, protein, fat, saturated fat, unsaturated fat, a mineral, a vitamin, an amino acid, a lipid, fiber, alcohol, caffeine, or any other food component. For example, a postmenopausal woman is advised to consume at least 1.5 grams of calcium per day. Consumption goals may be targets to be reached (e.g., at least 1.5 grams of calcium per day) or thresholds not to be exceeded (e.g., no more than 1500 calories per day).

In such embodiments, system 100 comprises means for entering nutritional consumption goals. In some embodiments, nutritional consumption goals may be entered via a device (for example, a personal computer, tablet or smartphone) operably linked to one or more component of the system. In some embodiments, one or more component of the system comprises means for entering nutritional consumption goals (e.g., a keypad or touch screen). In some embodiments, the means for entering food data also allow for entry of nutritional consumption goals. In some embodiments, the system comprises a food tray which comprises a keypad or touch screen through which information relating to nutritional consumption goals may be entered. In some embodiments, voice recognition technology is used to allow information relating to nutritional consumption goals to be entered vocally.

In these embodiments, system 100 further comprises a processing module operable to utilize the input data concerning consumption goals combined with the real-time consumption data and/or the results of calculations by the tracking and analysis engine to calculate progress towards one or more consumption goal. In various embodiments, this processing module may be a component of the tracking and analysis engine, comprised within another component of system 100, or comprised within a device operably linked to one or more component of the system.

System 100 may further comprise means for displaying progress towards consumption goals. In some embodiments, the display may be the same display used to display food consumption data. The display may be on a screen comprised within a food tray, or on a separate a device (for example, a personal computer, tablet or smartphone) that is part of or operably linked to one or more component of the system. Progress towards consumption goals may be expressed as a percentage of the consumption target or threshold over a period of time or for a particular meal. Progress towards consumption goals for different nutritional components may be shown in a single display or graphed separately. In some embodiments, the system further comprises an encrypted upload link that allows automatic backup and uploading of food consumption data and data relating to consumption goals to a data center of choice, or secure sharing with friends, family, coaches, trainers, doctors, nutritionists, or with an online fitness or nutritional community.

In some embodiments, system 100 provides eating advice during the course of food consumption to assist subject 101 to regulate food intake. For example, by monitoring calorie consumption rate, the system can identify whether food is being eaten too rapidly, and may provide a message informing the subject that the subject is eating too rapidly. In a further example, individuals with neurological disease can sometimes forget to eat, so if no food consumption is detected during a defined time period, the system may provide a message reminding the subject to eat. The system may also detect if additional food has been added to the system while a subject is eating, for example, if the weight of on a load cell or other weighing device of the system increases during the course of food consumption. The system may then provide a message asking if the subject has taken an additional serving. The eating advice may be provided, for example, as messages on a display, or as voice messages from a speaker.

In some embodiments, the system may provide a signal or advice based upon nutritional consumption goals set by the subject, as discussed above. For example, the system may provide a signal or message to indicate when the subject is approaching thresholds or targets based upon the subject's consumption goals. For example, if the subject has a target of 600 calories for a given meal, a graph shown on a display may update progress towards that goal as the subject eats, or display messages indicating that the subject has almost reached the consumption target.

In some embodiments, the system comprises one or more timers. In some embodiments, a timer may be started when the subject takes a dose of a medication. The system may then provide eating advice to the subject based upon the time since the medicine dose. For example, in the case of a subject with diabetes, the system may advise the subject to eat something within 10 minutes of taking a dose of insulin. In the case of a subject taking medication the function of which is affected by consumption of certain foods, the system may advise the subject not to consume foods containing that nutrient within a certain time from the medication dose.

In some embodiments, real-time consumption information is used to signal or send instructions to a control device 140 (step 125). Control device 140 may be configured to administer a drug to subject 101, or to provide information to a decision maker in the form of a display or report. When used in a hospital or nursing care facility with a subject 101 who is a patient, the automatic transmission of data to an institutional database (i.e., central data repository 150) can enable information on dietary intake and nutrition to appear in the patient's chart. Automating this aspect of a patient's chart enables significant improvement in the accuracy and timeliness of intake information.

In an embodiment, system 100, or a subset of its components, is used in conjunction with an insulin delivery device to facilitate and optimize blood glucose levels in diabetic individuals on insulin. For example, at the commencement of eating and before food is consumed, there is a “cephalic phase” of insulin secretion from a normally functioning pancreas. Individuals with diabetes often lack this cephalic phase of insulin release. A normal pancreas releases insulin in parallel with the rise in blood glucose resulting from the ingestion of carbohydrates. Individuals with diabetes are currently administered insulin as a single large dose prior to eating based upon the carbohydrates they intend to consume or as a single large dose after eating based upon the amount of carbohydrates consumed. The administration of a single large insulin dose before or after meals does not mimic the function of a normal pancreas. Thus in some embodiments, real-time information on food consumption enables a diabetic to administer insulin in a fashion which mimics normal pancreatic function, in particular, the cephalic phase of insulin secretion and insulin delivery in parallel with carbohydrate consumption.

There are numerous insulin delivery systems known in the art, including insulin pens and insulin pumps. In some embodiments, control device 140 comprises such an insulin delivery system, adapted to receive food consumption information and programmed to deliver a selected quantity of insulin based upon this information. For example, a subject's insulin delivery system may be programmed to deliver one unit of insulin for every 15 grams of carbohydrates consumed. The system monitors carbohydrate detection as discussed above, and informs the insulin delivery system when 15 grams of carbohydrates have been consumed. Thus, insulin delivery is coupled in real time to carbohydrate consumption. The system also enables mimicking of the cephalic phase of insulin secretion by detecting the initiation of food consumption, for example via initiator 340. Upon detection of the initiation of food consumption, the insulin detection system is notified so that an initial insulin dose, equivalent to the cephalic phase of insulin secretion, is administered. A record of the information sent to the insulin delivery system may also be included in a patient's database and medical chart.

In one exemplary embodiment, a diabetic subject, for example, a patient at a hospital, receives breakfast served on smart tray 310. The breakfast consists of scrambled eggs, a slice of cantaloupe, a bagel, jam, butter, a glass of orange juice, a cup of coffee, and a container of milk. Each of these items is placed upon a discrete section of smart tray 310. Smart tray 310 is configured, using one or more scales 320 and reader/sensors 330 to determine the weight of each individual item in each discrete section of the tray. Information regarding the specific food item in each discrete section of the tray is entered via a remote control device which provides a list of foods from which the specific items on the tray are selected. This process may be automated by the use of scanned menus. Subject 101 begins to eat by first opening the band surrounding the utensils provided with the tray. The opening of the band signals the insulin delivery system to deliver a defined dose of insulin. Next, the patient drinks half the glass of orange juice and replaces the half-empty glass back on smart tray 310. Smart tray 310 identifies that 125 grams of orange juice was consumed and sends a signal to the insulin delivery device that 12.9 grams of carbohydrate was ingested. Next, the subject decides to eat the cantaloupe. Smart tray 310 detects that 100 grams of cantaloupe were eaten and sends a signal to the insulin delivery device that 7.5 grams of carbohydrate were consumed. The patient continues to eat the scrambled eggs, bagel, and black coffee. Weights and carbohydrate intake are detected and intake information is transmitted to the insulin delivery system. A display on the subject's tray indicates the weight and calories consumed of each food item, as well as the weight of carbohydrates, protein, fat, essential amino acids, minerals, and vitamins which have been ingested. This information may also be transmitted to the hospital's patient database (i.e., central data repository 150), where the information is recorded for filing in the subject's electronic chart.

While the above describes a specific embodiment in which the subject is a diabetic patient and the consumption of carbohydrates is monitored and transmitted to an insulin delivery system, the systems and methods of the invention may also be used for subjects having any other disease or condition for which a specialized diet is recommended or for which the monitoring of one or more nutrients would be useful in diagnosis or treatment, such as conditions including but not limited to, liver disease, heart disease or heart failure, kidney disease or kidney failure, pancreatic disease, hypertension, hyperlipidemia, hypercholesterolemia, Meniere's disease, an inborn disorder of metabolism (e.g., phenylketonuria), and obesity. The systems and methods of the invention may also be used to monitor food consumption of subjects who desire to regulate their consumption of total calories or of nutrients such as saturated fats so as to aid in the prevention of conditions such as obesity or heart disease.

In various non-limiting applications, the systems and methods of the invention may be used to monitor the consumption of carbohydrates by a subject with diabetes; protein and/or carbohydrates by a subject with liver disease; protein, sodium, potassium, and/or phosphorus by a subject with chronic kidney disease; trans fats and/or sodium by a subject with heart disease; fats by a subject with chronic pancreatitis, sodium by a subject with hypertension; sodium by a subject with Meniere's disease; phenylalanine by a subject with phenylkentonuria; fiber by a subject with chronic constipation; and/or consumption of calories by a subject with obesity. By providing real-time information, the systems and methods of the invention allow for determination of when, during the course of food consumption, the recommended amount of a particular nutritional component has been reached, thus enabling individuals to comply with dietary recommendations.

In further applications, the systems and methods of the invention may be used to monitor the consumption of any other nutritional constituent for which there is information on the amount of the nutritional constituent in multiple foods. For example, gluten consumption could be measured, if the system comprised a database containing information on the gluten content of foods. Thus the systems and methods of the invention could be useful for individuals with food allergies or intolerances to monitor their intake of substances to which they are sensitive, for example, gluten in the case of individuals with celiac disease.

In further applications, the systems and methods of the invention may be used by individuals who desire to monitor their food and nutrient consumption for various fitness and training purposes. Such individuals may include, for example, biometrics enthusiasts who desire to track personal food consumption statistics, or performance-driven athletes, for example, a marathon runner attempting to optimize and track carbohydrate intake in advance of a race. The systems and methods of the invention may be used as a uniquely accurate food journal, allowing individuals to track and record their consumption of calories and or any other nutritional component.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

All patent and literature references cited in the present specification are hereby incorporated by reference in their entirety.

1. A system for monitoring food consumption of a subject, comprising:
a registration system configured to receive food data comprising nutrients and/or calories contained in one or more food items served to the subject;
an intake detection system configured to detect consumption of said one or more food items, thereby generating real-time food consumption data; and
a tracking and analysis system configured to receive food data from said registration system and consumption data from said intake detection system, and configured to utilize said food data and said consumption data to calculate a total amount of one or more nutrients and/or calories consumed by the subject.

2. The system of claim 1, wherein the intake detection system detects consumption of one or more food items by measuring a change of weight; a change of volume; a change in the amount of a detectable label present in the food item; or mouthfuls of food taken by the subject.

3. The system of claim 2, wherein the intake detection system comprises one or more sensing devices configured to detect a change in weight in one or more food items served to the subject as it is consumed by the subject.

4. The system of claim 3, wherein the intake detection system comprises a tray, wherein the tray comprises one or more sensing devices configured to detect a change in weight of one or more food items on the tray as said one or more food items are consumed by the subject.

5. The system of claim 4, wherein the tray comprises a plurality of discrete regions, and wherein the one or more sensing device is configured to detect a change in weight occurring in one or more of said plurality of discrete regions.

6. The system of claim 3, wherein the sensing device comprises a weighing device operably connected to a sensor.

7. The system of claim 1, wherein the system comprises a user interface configured so that a user can input one or more type of information selected from the group consisting of food data, nutritional consumption goals, and data concerning the weights of utensils and food vessels used to serve one or more food items.

8. The system of claim 1, wherein the system comprises a display device operably linked to the tracking and analysis engine and configured to display an amount of one or more nutrients and/or calories consumed by the subject.

9. The system of claim 1, wherein the intake detection system further comprises an initiator configured to detect the commencement of food consumption.

10. The system of claim 1, further comprising one or more external data sources operably connected to the registration system and/or one or more data repositories operably connected to the tracking and analysis system.

11. The system of claim 1, further comprising a control device configured to receive data from the tracking and analysis system.

12. The system of claim 11, wherein the control device is a drug delivery system which delivers a drug to the subject based upon the amount of one or more nutrients consumed by the subject as calculated by the tracking and analysis system.

13. A food tray comprising:
a data interface configured to receive food data associated with one or more food items on the food tray;
a sensing device configured to detect a change in weight of one or more food items on the tray, thereby generating real-time food consumption data;
an analysis module configured to analyze the food data and the real-time food consumption data to generate consumption analysis data providing the total amount of one or more nutrients and/or calories consumed by the subject; and
a memory configured to store at least one of the food data, the consumption data, and the consumption analysis data.

14. The food tray of claim 13, comprising a plurality of discrete regions, and a plurality of sensing devices, wherein each of the plurality of sensing devices is configured to detect a change in weight in one or more of the plurality of discrete regions.

15. The food tray of claim 13, wherein the sensing device comprises a weighing device operably connected to a sensor.

16. The food tray of claim 13 wherein the tray comprises two or more foldable segments, each segment comprising a scale, and wherein the foldable segments are configured so that the tray is convertible between an open and a folded configuration.

17. A method for monitoring food consumption in a subject, comprising:
receiving and storing food data comprising nutrients and/or calories contained in one or more food items served to the subject;
detecting the initiation of food consumption by the subject;
obtaining real-time food consumption data;
processing the food data and the real-time food consumption data to calculate consumption analysis data including a total amount of one or more nutrients and/or calories consumed by the subject.

18. The method of claim 17, wherein food consumption data is determined by detecting a change in weight in one or more food items served to the subject as it is consumed by the subject.

19. The method of claim 17, further comprising receiving and storing data concerning consumption goals for one or more nutritional component, and utilizing said data in combination with the consumption analysis data to calculate progress towards the goal.

20. The method of claim 17, further comprising sending information or instructions to a control device, wherein the control device is a drug delivery system which delivers a drug to the subject based upon the amount of one or more nutrients consumed by the subject.
